(19) United States
(12) Patent Application Publication
(10) Pub. No.: US 2008/0177674 A1
(43) Pub. Date: Jul. 24, 2008

(54) Financial instrument

(75) Inventor: Roy Meir, Petach Tikva (IL)

Correspondence Address: Davidson, Davidson & Kappel, LLC, 485 7th Avenue, 14th Floor, New York, NY, 10018, US

(73) Assignee: Simodan Hitum Vehanpakot (1993) Ltd., Petach Tikva (IL)

(21) Appl. No.: 11/657,364

(22) Filed: Jan. 24, 2007

(51) Int. Cl. G06Q 40/00

(52) U.S. Cl. 705/36 R

(57) ABSTRACT

An improved financial instrument for the simultaneous issuing of an underlying financial asset such as a bond asset and an associated protective option both having a substantially long lifetime and an identical expiration date is disclosed. The financial asset and the associated protective option are offered as an integral financial package for a potential purchaser for purchase and optional trading on a financial market. The protective option part of the instrument provides hedging of the risk involved in the purchase of the package. A related computerized system and method, which provides integral financial package creation, package document output and package-specific option calculation through the acquisition of remote and local option-specific data and specific option pricing calculation modules, is also disclosed.

### BACKGROUND OF THE INVENTION

1. Field of the Invention

The present invention relates generally to an improved financial instrument designed to operate on the financial markets. More specifically the present invention provides a financial instrument designed for the simultaneous issuing of a purchasable asset and an associated protective option where the asset and the protective option are having a common expiration date. The present invention further provides a computerized system and associated method for the simultaneous issuance of the asset and the associated option and for calculating the price of the protective option at any point in time during the lifetime of the asset and the option.

2. Discussion of the Related Art

An “option” is generally used to hedge risk by providing the right to purchase or sell an asset at later time at a set price with only limited obligation. An option is similar to an insurance policy in that it insures that an asset may be purchased or sold at a later time at a set price in return of a premium, which is generally small percentage of the current value of the asset. One type of option is the “put” option. A “put” option gives the purchaser of the option the right, but not the obligation, to sell a particular asset at a later time at a guaranteed price usually referred to as the exercise price. The “put” option may be thought of as giving the owner the right to “put” the security into another's name at the exercise price. In either instance, the seller of put option is obligated to perform the associated transactions if the purchaser chooses to exercise its option. Options are utilized in a variety of asset-based transactions. For example, in the security markets, security holders often enter into option relationships with security purchasers.

In the recent years financial institutions, such as insurance companies, mutual funds, savings funds, pension funds and the like, have been facing a growing trend of redemptions. This trend creates a continuously increased rate of non-liquid investments in the funds. As a result of this widespread trend, in order to hedge risks connected with the volatility of the financial market, the above-mentioned financial institutions are inclined to invest in non-tradable assets such as banking deposits, which are value-linked to the cost of living index.

At the same time financing companies operating on the market, such as mortgage banks, for example, are facing a persistent and acute funding shortage. In all probability this shortage will continue and may grow even critical as long as the current trend of redemptions from the reserves of the financial institutions, such as savings funds, mutual funds, insurance companies and the like, will continue.

These institutions hold financial assets on the order of billions. Two third of these assets are bond funds (with fixed volume). But as the funds are limited by the regulations to invest in non-tradable assets, these funds are not a viable financial source to the mortgage banks.

The system and method proposed by the present invention regards a financial instrument designed to provide a solution to above-mentioned problems. The financial instrument will attract investments that will ease the fund shortage experienced by diverse financing institutions, such as mortgage banks for example, by providing an investment package comprising purchasable bonds and associated purchasable protective put bond options. The protective put option will be utilized as a hedging device for the provision of substantially risk-free investments for the investors purchasing the investment package. The financial instrument is designed to simultaneously issue purchasable assets and associated protective options where the asset and the option have a common expiration date.

### SUMMARY OF THE PRESENT INVENTION

One aspect of the present invention regards a financial instrument that includes an underlying financial asset issued on a financial market and offered for purchase to a potential purchaser, and an associated protective option issued simultaneously with the underlying financial asset on the financial market and offered for purchase to the potential purchaser of the underlying financial asset in order to hedge risk involved in the purchase of the underlying financial asset such that the financial instrument provides the issuer of the underlying financial asset and the associated protective option new long-range financing sources with interest rates substantially than the standard interest rate on the financial market.

A second aspect of the present invention regards a computerized system for the processing of at least one integrated financial package. The system includes at least one client device having a display device, a communications device, an output device, an input device, a processor device, and a memory device to provide for the option of creating at least one integrated financial package, to transmit transaction-specific local and remote information to at least one end user of at least one client device, at least one server device to accept transaction-specific requests for remote data submitted by the at least one end user of the at least one client device, to access the remote data and to transmit the remote data to the at least one end user of the at least one client device, and at least one quotation source to receive option transaction-specific information and transmit the information to the at least one server device in accordance with requests submitted by at least one end user of the at least one client device.

A third aspect of the present invention regards a method of integrated financial package processing The method includes building at least one integrated financial package template, outputting at least one document representing the at least one integrated financial package, and performing at least one query concerning the at least one integrated financial package.

### BRIEF DESCRIPTION OF THE DRAWINGS

The present invention will be understood and appreciated more fully from the following detailed description taken in conjunction with the drawings in which:

FIG. 1A is a block diagram illustrating the structure of a simplified computing and communications system that could be operative in the implementation of the present invention;

FIG. 1B is a block diagram illustrating an alternative structure of a computing and communications system that could be operative in the implementation of the present invention;

FIG. 2 is a block diagram illustrating the operative components of the user device, in accordance with the preferred embodiment of the present invention; and

FIG. 3 is a flowchart that shows the method for the creation of the integrated financial package template, for the printing of the asset and option documents and for the option price calculation.

### DETAILED DESCRIPTION OF THE PREFERRED EMBODIMENT

The present invention proposes an improved financial instrument for ease the shortage of funds for financing companies, such as mortgage banks, for example. In accordance with the preferred embodiment of the invention the financing company such as a mortgage bank for example will issue bonds, value-linked to the cost of living index, having a lifetime of 15-year with the interest paid annually, where the principal is paid at the expiration date. Simultaneously with the issuance of the bond a “put” bond option (linked to the bond) will be issued. The put option provides the right to the potential purchasers, such as insurance companies, pension funds, savings funds, mutual funds and the like to return the bond to the issuer, such as the mortgage bank for example, at any point in time at a price, which is the adjusted price of the bond. It is important to note that the improved financial instrument is designed such that the bonds and the associated options will be traded on the stock market separately.

Alternatively, the put option could be described as a payment calculated as the difference between the adjusted price of the bond and the price of the bond on the market. For example, the bond will be issued with an interest rate that is about 0.5% lower than the commonly provided interest rate for a deposit value-linked to the cost of living index for the same period.

The issuance of bonds involves a number of expenses. In order to describe the advantages of the proposed financial instrument an exemplary list of expenses and associated calculations will be provided next. The following description is non-limiting as different expenses and calculations could be involved in the issuance of different bonds and associated options under varied circumstances. An exemplary list of the associated expenses could consist of the following:

| | |
|---|---|
| Stamps | about 0.4% |
| Distribution costs | about 0.4% |
| Legal costs and printing costs | about 0.5% |
| Underwriters and commission | about 0.5% |
| Total | about 1.8% |

To continue the description of the conditions involved in the exemplary issuance, the cost of raising the capital in the above detailed case will be about 0.38% lower than the market price for a year (1.8/15=0.12) for example. As the bond will be issued via a tender there is a theoretical possibility that the selling price will be higher than 100 i.e., a further lowering of the capital raising costs will be effected. In the framework of the capital raising costs no underwriting costs were considered, as the issue will be made without underwriting but by early sale to institutional investors. If the total sale of the bonds will not reach at least 100 million the issue will not be completed.

The system and method suggested by the invention provide the following advantages to the potential purchasers, such as insurance companies, pension funds, savings funds, mutual funds and the like, of the package: a) The purchase of the entire integrated financial package consisting of a bond and an associated bond option package will provide the potential purchaser that the investment will not show up in the books as real loss for the lifetime of the bond and option package (from the issuance date to the expiration date) since the losses affected by the falling of the bond prices on the market (as a result of the rising interest rates) will be offset by a corresponding rise in the price of the put option. In case the interest rates will decline, the bond will behave as a typical long-range bond. It means that the risk for the purchaser of the bond is limited as a bond for a single year (the first year only) but if the interest rate will decline the bond will behave like a 15-year bond.

When buying the integrated financial package consisting of the bond and the associated bond option the purchasers will receive a slightly reduced interest payment, as the interest rate associated with the bond is slightly lower than the standard interest rate for the same period.

The financial instrument proposed by the present invention imparts important advantages to the issuer: a) the provision of long-range financing source with an interest rate lower than the standard interest rate of the market. b) The provision of new sources of funding, such as insurance companies, pension funds, savings funds, mutual funds and the like.

The use of financial instrument proposed by the present invention involves a certain potential risk to the issuer, such as a mortgage bank for example. The risk concerns the exercising of the option by the purchaser i.e., a loss valued as the difference between the adjusted price of the bond and the market price. This potential risk to the issuer is substantially offset by the following facts: a) Options are typically traded on the market above their theoretical price. Consequently the exercising of an option will affect a loss to the holder of the option. For example, in case a bond is issued with a rate of 100 points with an interest of about 4.8% then if the interest rate is rises by about 1% i.e., the value of the bond falls to about 85 points in order that the yield about 5.8%, the value of the option will be about 15 points (naïve value) and according to the Black & Scholes equation about 77 points. The higher difference between the value of the option by Black & Scholes and the naïve value results from the lifetime of the option (up to 15 years). The analysis of trading figures collected from about 75 options traded on the market (in a period of stock market depression) shows that the majority is traded with a premium of about 50-70% above to their theoretical value. It can be assumed that in a period of market upswing the above-mentioned options will be traded with premiums that are much higher than their theoretical values. Thus, the bond option will be traded with a premium higher to its theoretical value when the interest rates are rising. The dividend will provide that the put option will not be exercised as the holder of the package consisting of the bond and the associated bond option will enjoy a combined worth, which is substantially higher according to the market price than that of the immediate selling price. This analysis is further supported by analyzing the behavior of the put options as shown by the market indices in trading periods characterized by moderate downswings in the prices. b) The issuer could purchase the option on the market and thereby limiting the risk. For example, when the interest rate drops and the bond value rises above 100% (adjusted value), the option will have a negative value. Since there is no trading in negative values on the market the value of the option technically will be 10 points. At this value the issuer is enabled to purchase options in order to prevent future risk.

The system and method proposed by the present invention provides to an issuer such as a mortgage bank for example, an improved process regarding the issuance of the purchasable asset and associated bond option. The system and method further includes a bond option value calculation. In the preferred embodiment of the present invention the processes will be referred to hereunder as the Integrated Financial Package Application (IFPA) Consequent to the complexity of the calculations required by the suggested parameters of package comprising the issued bond and the associated bond option, in the preferred embodiments of the invention, the method is implemented in a computing and communications environment. The various aspects of the system and method proposed by the present invention could be implemented on a wide variety of computer systems. In the preferred embodiment of the present invention a client/server network is utilized as the basic framework within which the IFPA operates. Note should be taken that other similar computer networks and system frameworks could be similarly employed in the working of this invention.

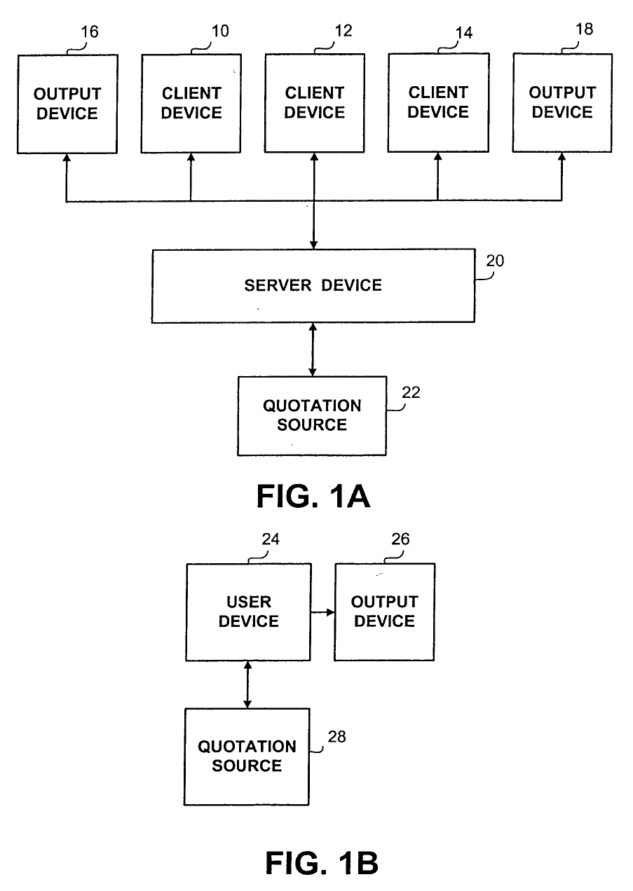

Referencing FIG. 1A which shows an exemplary client/server environment in which the proposed system and method is implemented in order to allow utilization by the proposed method, in accordance with a preferred embodiment of the present invention. The system includes client devices 10, 12, 14, output devices 16, 18, a server device 20, and a quotation source 22. The client devices 10, 12, 14 are computing devices operated by the end users of the system such as the issuers of the bond and associated protective option. The devices 10, 12, and 14 could be personal computers having computing and communications capabilities. The devices 10, 12, 14 could also be any of the known client devices equipped with the suitable hardware interfaces, such as laptop computers, workstations, personal digital assistants, cellular phone devices, and the like. The devices 10, 12 and 14 are communicatively connected to the server device 20 utilizing known communications facilities. The facilities include standard communications software modules, communications hardware components, and standard communications channels. The communications channels could be land lines connections, satellite communications links and the like. The server device 20 is a computing device with communications capabilities. The device 20 is connected via suitable communications links to a quotation information source 22. The source 22 could be a Quotron system or its equivalent that receives suitable information relevant to the bond option transaction via a satellite communications link or landlines. The end users are using the client devices 10, 12, and 14 in order to create a package template concerning the issuance of the bond asset and the associated protective option and in order request and receive bond option-specific information from the quotation source 22 via the server device 20. Consequent to the transmission of the requested bond option-specific information to the requesting end-users the end-users are provided with the option of calculating the value of a specific bond option. The method utilizes a set of computer programs that could be implemented in each one of the client devices 10, 12, 14 or could be implemented on the server device 20. A more detailed description of the method will be set forth hereunder in association with the following drawings. The output devices 16, 18 are hardware devices, such as printers. The devices 16, 18 are operative in printing the package related documents and in displaying the values resulting from the execution of the bond option value calculation. Although on the drawing under discussion only a limited number of client devices, output devices and a single server device is shown it would be easily understood by one with ordinary skills in the art that in a practical system configuration a plurality of client devices and/or printer devices could be connected to a plurality of server devices. The client devices could be independent computing and communicating devices or could constitute a local area network, a wireless local area network, a set of workstations linked to a mainframe computers, a wide area network, a virtual private network and the like.

Referring now to FIG. 1B which shows an alternative system configuration across which the proposed system and method could be implemented, according to a preferred embodiment of the invention. The system illustrated includes a user device 24, an output device 26, and a quotation data source 28. The user device 24 is a stand-alone computer device having independent processing capabilities. The device 24 could one of a wide variety of computing devices, such as a personal computer, a laptop computer device, a personal digital assistance, a cellular telephone device, and the like. The device 24 is communicatively linked to a remote quotation information source 28. The link between device 24 and information source 28 is accomplished via standard communications components facilitating remote access such as communications software, communications hardware units and communications channels, such as traditional telephone lines, satellite links, or any other known communications lines. The remote quotation information source 28 could be a Quotron system or its equivalent. The source 28 receives relevant information via satellite communications links, landlines, or the like. An end-user operating the user device 24 submits package issuance requests to the application to accomplish the creation of package templates, and the outputting of package documents based on the existing templates. The end-user could also introduce bond option-specific queries to the quotation data source 28. Consequent to the transmission of the information the end-user is allowed to activate the IFP application 48 in order to calculate the value of a specific bond option. The output device 26 is controlled directly by the user device 24. The output device 26 is typically a printer device utilized for the printing of a hardcopy consisting of the bond asset and associated bond option documents and the optional printing of a hardcopy containing the results of the end-user's queries for bond-specific information and the results of the associated bond option value calculation.

The system configurations including the constituting devices and the manner of connections there between, which were illustrated and described in association with the prior drawings, were mentioned for illustrative purposes only and, as could be easily appreciated by one with ordinary skills in the art, could be substituted by a wide variety of equivalent system configurations.

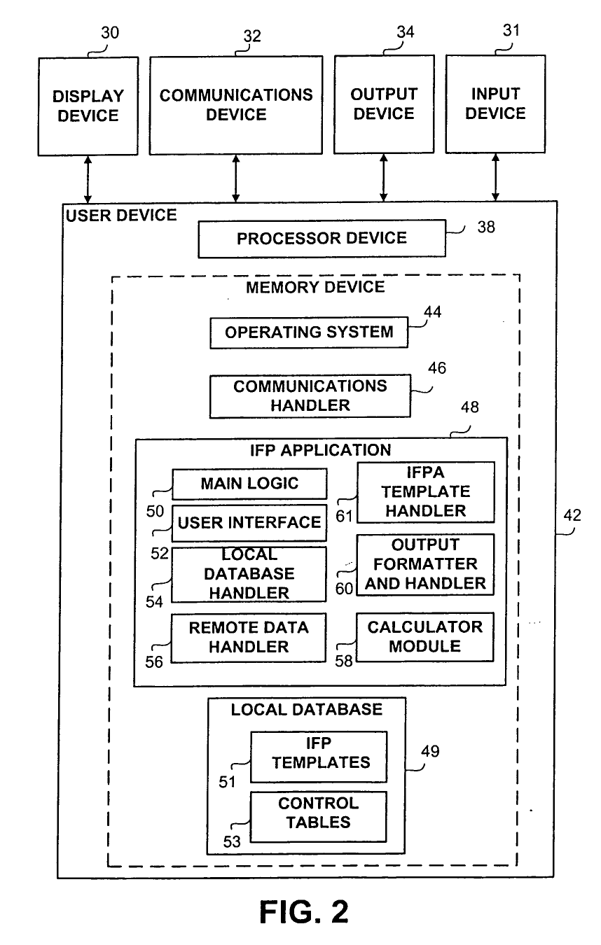

Referring now to FIG. 2, which illustrates the hardware components and functional software components constituting the user device 24 of FIG. 1B, in accordance with a preferred embodiment of the invention. For practical purposes the user device 24 of FIG. 1B is equivalent to the client device 10, 12, 14 of FIG. 1A. The user device 36 is a computing platform such as a personal computer, laptop computer, Personal Digital Assistant (PDA), cellular phone or the like, having suitable computing and communications capabilities. The user device 36 is integrally connected to a display device 30, an input device 31, a communications device 32, and an output device 34. The display device 30 is typically a video display unit utilized as a hardware interface between an end-user and the user device 34. The input device 31 could be a keyboard, a pointing device or the like. The device 31 is utilized by the end-user to communicate with the user device 36. The communications device 32 is used for the linking of the user device 36 to the suitable communications channels. The device 32 could be a modem or a Network Interface Card (NIC). The output device 34 is typically a printer and is used for the printing of a hardcopy.

The user device 36 includes a processor device 38, and a memory device 42. The processor device 38 is a CPU or a microprocessor operative in the execution of the program instructions included in the various functional software routines that are running on the computing platform. The processor device 38 is made up of electronic circuitry consisting of a plurality of elements organized into specific functional operating units such as arithmetic units, cache memory, memory management, predictive logic, and data movement. The processor device 38 typically includes an arithmetic logic unit, a floating-point unit, a load-store unit, a memory management unit, and a branch and vector-processing unit. The processor device 38 could be any of the known processor units such as the Pentium series manufactured by Intel or the like.

The memory device 42 is typically a hard disk. The device 42 is operative in storing the suitable software modules and associated data. The memory device 42 includes an operating system 44, a communication handler 46, the integrated Financial Package Application (IFPA) 48, and a local database 49. The operating system 44 is a program that, after being initially loaded into the computer by a boot program, manages all the other programs in a computer. All computer platforms require and typically include an operating system. The operating system 44 could be one of a wide variety of systems such as UNIX, Windows 98, Windows NT, OS/2, AIX, MacOS, PalmOS or the like. The communications handler 46 is a set of standard computer programs, which is responsible for the creation of the appropriate communications channels by introducing suitable requests to the communications device 32. The IFPA 48 is a set of specifically written computer programs operative in the processing of the bond option transactions. The IFPA 48 could include specific standard modules for the calculation of the bond option value, specifically modified standard modules, or specifically developed original modules. The IFPA 48 includes a main logic component 50, a user interface component 52, a local database handler 54, a communications handler 56, a calculator component 58, an IFP template handler 61, and an output formatter and handler 60. The main logic component 50 is responsible for the activation of the various components of the IFPA 48, and for the co-ordination between the application components. The user interface 52 is operative in the creation and resolution of the dialog between the end-user and the application 42. The local database handler 54 accesses the local database in order to obtain the information necessary for the performance of the bond option calculation. The remote data handler 56 is operative in the transmission of the bond option-specific requests received from the user interface 52 to the communication handler 46. Consequently the quotation data source 28 of FIG. 1B is accessed by the setting up of a suitable communication channel and the requested information is transmitted from the quotation data source 28 of FIG. 1B. After the remote data handler 56 will receive the remote data the received information will be passed to the appropriate application software component such as the user interface 52 or the calculator module 58. The task of the calculator module 58 is to perform the appropriate bond option-specific transaction such as calculating the value of the option. The calculator module 58 could utilize one of the several widely used option pricing routines, such as the Black-Scholes routine, the Binominal Pricing routine, the Finite Difference routine, and the Analytic Approximation routine. The calculator module 58 could use any other available pricing routine or could use a specifically modified version of one or more of the above listed routines. The output handler and formatter component 60 is operative in the formatting and printing of the asset and associated option documents for distribution, in the formatting and printing of the information received by the end-user inquiries and in the formatting and printing the results of the bond option transactions. The local database 49 is a set of data structures designed specifically to hold data necessary for the operation of the IFPA 48. The database 49 includes IFPA templates 51, and control tables 53. The IFPA templates 51 are specific data structures holding data that describes the integrated financial packages concerning the parameters of the issued bond asset with the associated protective option. For example the IFPA templates 51 store the common expiration date of the package. The control tables 53 store data relevant to the operation of the application 48. For example tables 53 could hold information concerning the up-to-date list of issued assets and options, asset price, option types, margins and the like.

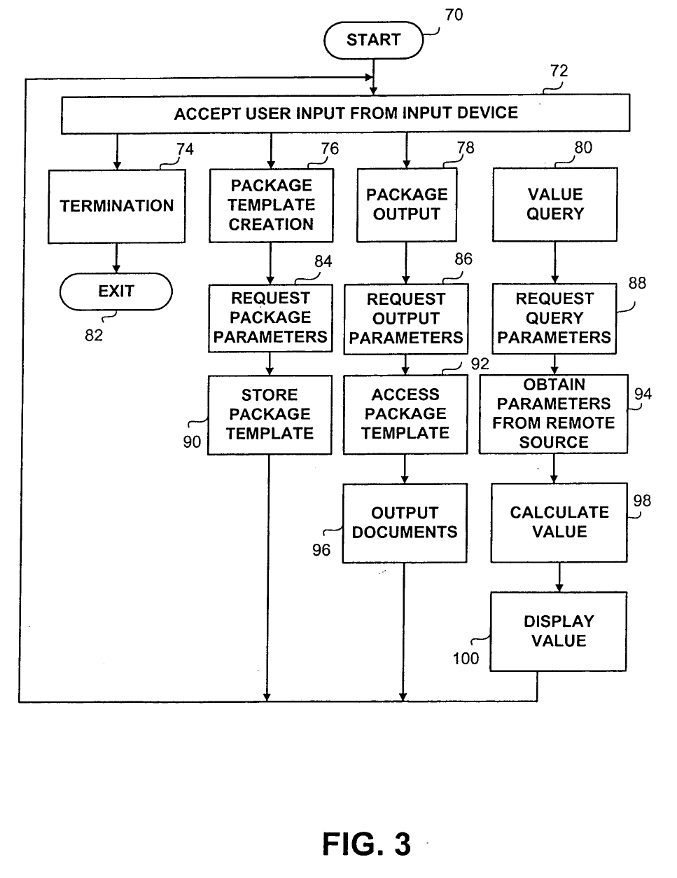

Referring now to FIG. 3 that shows an exemplary flowchart describing the logic flow of the IFPA application 48. The application 48 is activated by an end-user, such as a Integrated Financial Package issuer. The activation is performed via the client device 10, 12, 14, 18 of FIG. 1A and/or via the client device 24, 26 of FIG. 1B. It would be easily understood that within a computer network a plurality of client devices could interface to and operate the IFPA 48 simultaneously. In the preferred embodiment of the invention the set of computer programs and data structures constituting the proposed system and method are installed separately on each client device 10, 12, 14, 18, 24, 24, 26 it would be easily understood that in other preferred embodiments the programs and data structures could be implemented on centrally connected computing devices such as service device 20 of FIG. 1A.

Still referring to FIG. 3, at step 70 the application 48 is activated. At step 72 the user input is received from a client input device. In the preferred embodiment of the invention the end-user is provided with a limited number of options; a) terminating the running of the programs (step 74), b) creating a package template associated with the simultaneous issuance of an asset and a protective option (step 76), c) outputting package documents for distribution among purchasers or agents (step 78), and d) submitting queries regarding the value of a specific protective option (step 80). The above options are exemplary only and the description is not meant to be limiting in any sense. In other preferred embodiments additional operations could be added, some operations could be removed, and existing operations could be improved, modified and enhanced. When an end-user submits a request for the termination of the program (step 74) the program control exits the application 48 at step 82 and returns control to the operating system 44 of FIG. 2. If an end-user desires to create a package template (step 76) then at step 84 the program requests the suitable package parameters from the end-user (step 84). The package parameters could include for example, the package identification, the creation date, the number of units for sale, the expiration date, the type of the asset, the type of the associated option, the initial price of the asset, and the like. Some or all of the received parameters could be suitably verified and validated against the control values stored within the control tables 53 in the local database 49. At step 90 the package template including the underlying asset and the associated protective option is created, stored within the IFP templates list 61 in the local database 49, and program control proceeds to step 72 to receive a further request from the end-user. The process of template creation is the first stage in the issuing of the integrated financial package.

When the end-user initiates the printing of the integrated financial package at step 78 then the program logic affects the request of the output parameters at step 86. For example, the appropriate parameters could include the package identification, the number of units to print, the type of the documents to print (asset, option or both), the purchaser identification, the printing date and the like. Consequently at step 96 the requested documents are printed on a selected output device such as output device 30 of FIG. 1A. Following the completion of the outputting process program control proceeds to step 72 to receive further requests from the end-user.

The end-user is provided with the option of submitting queries (step 80) regarding the value of a specific option. When the end-user input is identified as a query (step 80) the following steps are performed. At step 82 the program requests the query parameters from the end-user. For example, the query parameters could include, the option type, the package identification, the expiration data, and the like. Optionally the some of the necessary parameters could be obtained from a remote source such as the quotation source 22 of FIG. 1 or the quotation source 28 of FIG. 1B. At step 98 the value of the option is calculated, and at step 100 the requested information is displayed to the end-user. Subsequently program control proceeds to step 72 in order to receive additional requests from the user.

The Black-Scholes routine is widely used in connection with determining option premiums. Therefore, in the preferred embodiment of the present invention the Black-Scholes option pricing routine is used for calculating the value of the bond option. The Black-Scholes routine is available in both proprietary and shareware versions.

Persons skilled in the art that the present invention is not limited to what has been particularly shown and described hereinabove will appreciate it. Rather the scope of the present invention is defined only by the claims, which follow.

I/We claim:

1. Within a computer system having at least one storage device and at least one output device, an integrated financial instrument to be utilized as a capital raising and investment tool having a substantially long lifetime comprising:
an underlying financial asset issued for trade on a financial market and offered for purchase to a potential purchaser;
an associated protective option issued simultaneously with the underlying financial asset for trade on the financial market and offered for purchase to the potential purchaser of the underlying financial asset in order to hedge risk involved in the purchase of the underlying financial asset;
where the underlying financial asset and the associated protective option are having a common expiration date;
thereby providing to the issuer of the underlying financial asset and the associated protective option long-range financing sources with interest rates substantially lower than the standard interest rate on the financial market.

2. The apparatus of claim 1 wherein the underlying financial asset is a bond asset.

3. The apparatus of claim 1 wherein the underlying financial asset is value-linked to the cost of living index.

4. The apparatus of claim 1 wherein the underlying financial asset is issued as having a lifetime of up to 15 years.

5. The apparatus of claim 1 wherein the associated protective option is a put option to provide the right to the purchaser to return the underlying financial asset to the issuer at any point in time at the adjusted price of the financial asset.

6. The apparatus of claim 1 wherein the associated protective option is issued as having the lifetime of up to 15 years.

7. The apparatus of claim 1 wherein the underlying financial asset and the associated bond option are traded on the financial market as a linked package.

8. The apparatus of claim 1 wherein the underlying financial asset and the associated bond option are traded on the financial market separately.

9. The apparatus of claim 1 wherein the value associated protective option is calculated as the difference between the adjusted price of the underlying financial asset and the price of the underlying financial asset on the financial market.

10. The apparatus of claim 1 wherein the underlying financial asset is issued with an interest rate that is 0.5% lower than the commonly provided interest rate for a cost-of-living value-linked deposit.

11. The apparatus of claim 1 wherein the purchase of the underlying financial asset and the associated protective option do not appear in the records of the purchaser as real loss for the lifetime of the underlying financial asset and the associated protective option.

12. The apparatus of claim 1 wherein the falling of the bond asset prices on the financial market will be offset by a corresponding rise in the price of the protective option.

13. The apparatus of claim 1 wherein the decline of the interest rates in the financial market will affect the underlying financial asset as a typical long-range bond asset.

14. A computerized system for an integrated financial package application comprising:
at least one client device having a display device, a communications device, an output device, an input device, a processor device, and a memory device to provide for the creation of an integrated financial package including a bond asset and a protective option, and to provide for option transaction-specific local and remote information to at least one end user;
at least one server device to accept option transaction-specific requests for remote data submitted by the at least one end user of the at least one client device, to access the remote data and to transmit the remote data to the at least one end user of the at least one client device; and
at least one quotation source to receive option transaction-specific information and transmit the information to the at least one server device in accordance with requests submitted by at least one end user of the at least one client device.

15. The system of claim 14 wherein the memory device comprises:
an operating system to supervise, to control, and to coordinate the various computer programs running on the at least one client device;
a communications handler to provide for communication between the at least one client device, and the at least one server device;
an integrated financial package application to accept requests for integrated financial package template creation from at least one client device, to perform package template creation, to accept requests for package document output from at least one client device, to perform document output, to accept calculation requests from at least one client device, to perform the requested calculations and to display the results to the at least one end user.

16. The system of claim 15 wherein the integrated financial package application comprises:
a main logic component to control the comprehensive operation of the application;
a user interface to provide communication between the at least one end user of at least one client device and the integrated financial package application;
a local database handler to access, to extract and update a local database holding parameters operative in the running of the integrated financial package application;
a remote data handler to access the information provided by the at least one quotation source operative in the performance of specific aspects of the integrated financial package application;
a calculator component to accept local and remote parameters operative in specific aspects of the protective option value calculation and to perform the calculation according to the communication of the user of the client device;
an output formatter and handler component to format and print integrated financial package documents, to display, print and otherwise show the operative parameters and the associated results of the protective option value calculation to the at least one end user of the at least one client device;
an integrated financial package template handler to receive requests from the at least one user of the at least one client device for the creation of the integrated financial package templates, to build the integrated financial templates, and to store the templates;
a local database to store the integrated financial package templates, and control information.

17. The system of claim 14 wherein the at least one client device is a personal computer.

18. The system of claim 17 wherein the at least one client device is a laptop computer.

19. The system of claim 17 wherein the at least one client device is a personal digital assistant.

20. The system of claim 15 wherein the at least one quotation source is a Quotron system.

21. The system of claim 16 wherein the calculator module component includes the Black-Scholes routine to be utilized as the protective option pricing routine.

22. The system of claim 21 wherein the calculator module component includes the Binominal Pricing routine to be utilized as the protective option pricing routine.

23. The system of claim 22 wherein the calculator module component includes the Finite Difference routine to be utilized as the protective option pricing routine.

24. A method of an integrated financial package processing comprising the steps of:
building at least one integrated financial package template;
outputting at least one document representing the integrated financial package;
performing at least one query concerning at least one integrated financial package.

25. The method of claim 24 wherein the step of building comprises the steps of:
requesting and obtaining integrated financial package-related parameters from at least one user of at least one client device;
validating the integrated financial package-related parameters;
creating at least one integrated financial package template including a financial asset and an associated protective option;
storing the at least one integrated financial package.

26. The method of claim 24 wherein the step of outputting comprises the steps of:
requesting and obtaining integrated financial package-related output parameters from at least one user of at least one client device;
verifying and validating the integrated financial package-related output parameters;
outputting at least one document representing at least one integrated financial package template including a financial asset and an associated protective option.

27. The method of claim 24 wherein the step of performing comprises the steps of:
requesting and obtaining integrated financial package-related query parameters from at least one user of at least one client device;
verifying and validating the integrated financial package-related query parameters;
obtaining integrated financial package-related parameters from at least one remote source;
displaying at least one result to the at least one integrated financial package related query.
